(19) United States
(12) Patent Application Publication
(10) Pub. No.: US 2003/0210448 A1
(43) Pub. Date: Nov. 13, 2003

(54) Systems and methods of reflective photonic modulation

(76) Inventor: Melvin I. Buchwald, N. Bethesda, MD (US)

Correspondence Address: Melvin I. Buchwald, 10831 BREWER HOUSE ROAD, N. BETHESDA, MD, 20852, US

(21) Appl. No.: 10/345,251

(22) Filed: Jan. 16, 2003

Related U.S. Application Data
(60) Provisional application No. 60/350,367, filed on Jan. 24, 2002.

(51) Int. Cl. G02B 26/00; G02F 1/00

(52) U.S. Cl. 359/237

(57) ABSTRACT

systems and methods wherein reflective modulation occurs, including selectively directing (including, but not limited to, switching or routing) an optical signal into one of at least two directions. The systems and methods selectively activate anti-Stokes transitions and thus facilitate the removal of energy, as radiative fluorescence emissions.

### CROSS REFERENCE TO RELATED APPLICATION

This application claims the priority to U.S. Provisional Application No. 60/350,367, filed Jan. 24, 2002, which is explicitly incorporated by reference in its entirety in this disclosure and for all purposes.

### BACKGROUND OF THE INVENTION

1. Field of Invention

The present invention relates to systems and methods of reflective photonic modulation. More particularly, the present invention relates to using anti-Stokes fluorescence in photonic modulation.

2. Description of Related Art

Exponentially increasing information accompanies social and technical progress. Such great and ever increasing amount of information requires ever increasing processing and routing capabilities, including ever-increasing speed. Generally, the increase in the capability of the information processor and information router has been achieved by miniaturizing or integrating the components forming the processor and router, or both.

The binary (or plural state) switch forms the building block of a processor or a router. An on/off switch or a diode, for example, can be used as the foundation for more complicated device and systems that perform analog or digital functions.

Switches use mechanical, electrical, or optical principles, or various combination thereof, to achieve the processing or routing function (whether analog or digital) of the system. A switch using a physical principle to process a signal or trigger its modulation enjoys advantages and suffers from disadvantages inherent to the principle.

An opto-mechanical switch is an example of a switch using mechanical principles. Opto-mechanical switches use moving (e.g., rotating or alternating) mirrors, prisms, holographic gratings, or other devices to deflect light. The mechanical action may involve motors or piezoelectric elements. An opto-mechanical switch may be integrated into an array of actuated micro-mirrors etched onto a silicon chip in a manner similar to that of electrical integrated circuits. The mirrors change angle based upon an electrical signal and route an incident optical signal to one of many outputs.

A switch using mechanical principles (the opto-mechanical switch, for example) may be easy to design and have low insertion loss and low, but such current switches suffer from difficulty in integrating to a miniaturized form because of manufacturing and heat removal requirements.

An electro-optic switch is an example of a switch using electrical principles. In an electro-optic switch, a material is used that alters its dielectric constant in the presence of an electric field. Such switches may be used as electrically controlled phase modulators or phase retarders. When placed in one arm of an interferometer, such as a Mach-Zender interferometer, or between two crossed polarizers, the electro-optic switch modulates the light propagating therethrough based on the electrical field of the applied electrical modulating signal. Lithium Niobate is the material most often used as the electro-optically-active material.

A switch using electrical principles (the electro-optic switch, for example) may be as fast as the modulating electrical signal, but such current switches suffer from the high cost of the electro-optically active material, the difficulty in creating low loss waveguide within it, and ultimate limits in miniaturizing the switch due to signal input/output and heat removal requirements.

An all-optical switch is an example of a switch using optical principles. In an all-optical switch, light controls light with the help of a nonlinear optical material, for example, which changes its properties when exposed to high intensity light beams (e.g., changing its index of refraction under high irradiation intensities by the Kerr effect). Such switches can be used as optically modulated phase modulators or retards. When placed in one leg of a Mach-Zender interferometer, for example, the all-optical switch modulates the light propagating therethrough based on the electrical field of the applied optical modulating signal.

A switch using optical principles (the all-optical switch, for example) may be as fast as the modulating optical pulse and have effectively unlimited bandwidth, but such current switches require high operating power and, therefore, have ultimate miniaturizing limits due to heat removal requirements.

### SUMMARY OF THE INVENTION

Recognizing the detrimental effect of heat in prohibiting miniaturization of switches, either through heat induced failure or structures that remove the heat, the disclosed invention provides modulation devices and methods wherein at least a portion of the energy that is involved in physical processes not contributing to the modulation action is channeled to radiative forms. A portion (or all) of the energy that is involved in physical processes not contributing to the modulation action can then be removed without causing the failure of the switch due to overheating or requiring auxiliary heat removing structures.

In its most basic form, the invention can be implemented as systems and methods wherein reflective modulation occurs, including selectively directing (including, but not limited to, switching or routing) an optical signal into one of at least two directions, and selectively activating anti-Stokes transitions and thus facilitating the removal of energy, as radiative fluorescence emissions.

In one exemplary embodiment, the disclosed invention includes a modulator selectively directing (including, but not limited to switching or routing) an optical signal into one of two directions, the switch including an element selectively having a component selectively undergoing anti-Stokes transitions and thus facilitating the removal of energy, as radiative fluorescence emissions, from the switch.

In another exemplary embodiment, a modulator includes a selectively reflective Fabry-Perot element, the element including an etalon having a material selectively undergoing anti-Stokes transitions and thus facilitating the removal of energy, as radiative fluorescence emissions, from the switch.

In yet another exemplary embodiment, a modulator includes a selectively reflective multilayer mirror, the mirror including at least one layer having a material selectively undergoing anti-Stokes transitions and thus facilitating the removal of energy, as radiative fluorescence emissions, from the switch.

In one exemplary process of practicing the invention, an optical modulation method includes arranging a selectively reflective Fabry-Perot element in the path of an optical signal, and including in the element an etalon having a material selectively undergoing anti-Stokes transitions and thus facilitating the removal of energy, as radiative fluorescence emissions.

These and other embodiments, features, and advantages of this invention are described in, or are apparent from, the following detailed description of the systems and methods according to exemplary embodiments of this invention.

### BRIEF DESCRIPTION OF THE DRAWINGS

The benefits of the present invention will be readily appreciated and understood from consideration of the following detailed description of exemplary embodiments of this invention, when taken together with the accompanying drawings, in which:

FIG. 1 is a block diagram of an exemplary device in accordance with a first embodiment of the invention;

FIG. 2 is a block diagram of an exemplary device in accordance with a second embodiment of the invention;

FIG. 3 is a block diagram of an exemplary device in accordance with a third embodiment of the invention;

FIG. 4 is a block diagram of an exemplary device in accordance with a fourth embodiment of the invention;

FIG. 5 is a block diagram of an exemplary device in accordance with a fifth embodiment of the invention; and

FIG. 6 is a flowchart depicting the steps of an exemplary method in accordance with the present invention.

### DETAILED DESCRIPTION OF PREFERRED EMBODIMENTS

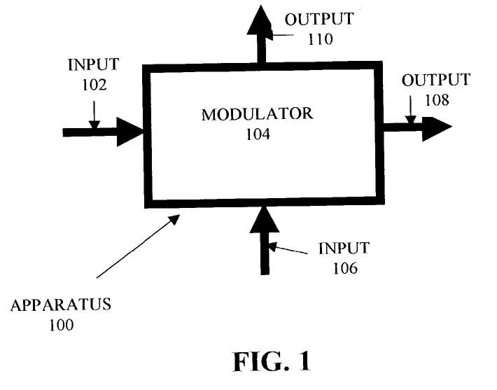

FIG. 1 is a block diagram showing an exemplary implementation of the invention as apparatus 100. The apparatus 100 at least includes a first input 102, a modulator 104 operatively connected to the first input 102, a second input 106 operatively connected to the modulator 104, an output 108 operatively connected to the modulator 104, and an output 110 operatively connected to the modulator 104.

During operation, the apparatus 100 can receive at input 102 an optical signal at wavelength λ₁. The optical signal can be delivered to input 102 by a free space or material waveguide. A fiber can be used to deliver the optical signal to input 102. Additionally, an optical relay arrangement (including, but not limited to, a lens or a mirror) can be used as an interface between the delivery waveguide and input 102. In various exemplary implementations, optionally, one or both of the waveguide and the interface can form part of apparatus 100.

During operation, the apparatus 100 can also receive at input 106 an optical signal at wavelength λ₂ (preferably different than wavelength λ₁). The optical signal can be delivered to input 106 by a free space or material waveguide. A fiber can be used to deliver the optical signal to input 106. Additionally, an optical relay arrangement (including, but not limited to, a lens or a mirror) can be used as an interface between the delivery waveguide and input 106. In various exemplary implementations, optionally, one or both of the waveguide and the interface can form part of apparatus 100.

The modulator 104 is operatively connected to the input 102, from which it receives the optical signal at wavelength λ₁. Optionally, the operative connection includes an optical relay arrangement implemented using a lens or a mirror, for example.

The modulator 104 is also operatively connected to the input 106, from which it receives the optical signal at wavelength λ₂. Optionally, the operative connection includes an optical relay arrangement implemented using a lens or a mirror, for example.

The modulator 104 is operatively arranged to selectively reflect or transmit the optical signal at wavelength λ₁, effectuated by the optical signal at wavelength λ₂. In an exemplary implementation, the modulator 104 is operatively arranged to constructively interfere or destructively interfere the optical signal at wavelength λ₁ and, thus, selectively transmit or reflect, respectively, the optical signal at wavelength λ₁. In an exemplary implementation, the optical signal at wavelength λ₂ effectuates the modulating action of the modulator 104 by changing the dielectric constant of the material forming element 104, which can lead to a change in the interference status (constructive or destructive) of the optical signal at wavelength λ₁.

The modulator 104 at least includes a component that selectively undergoes anti-Stokes transitions, preferably effectuated by the optical signal at wavelength λ₂. The selective effectuation of anti-Stokes transitions enables the removal of at least a portion of the energy that is involved in physical processes not contributing to the modulating action.

The basic physical principals of anti-Stokes fluorescence resulting in the selective radiative removal of energy is described in detail in U.S. Pat. Nos. 5,447,032 and 6,041,610 to Epstein et al. and Edwards et al., respectively, both explicitly incorporated by reference in their entirety in this disclosure and for all purposes. Briefly, consider a solid material at a temperature T_{c}, describing the distribution of phonons, and having a three level system with energies E₀, E₁, and E₂. The, anti-Stokes fluorescence occurs when the upper levels have an energy spacing not more than a few times the characteristic energy of thermal excitation, i.e., when E₂−E₁<(3-6)×kT_{c}, where k is Boltzmann constant. With this spacing the kinetic or nonradiative redistribution rate, due to phonon interactions, can be rapid between levels E₁ and E₂, and the relative population of these levels quickly approaches thermal equilibrium at temperature T_{c}. The energy gap between the ground state and the upper levels, on the other hand, must be much greater than kT_{c} so that nonradiative excitations from the ground state are strongly inhibited.

Light tuned to energy E₁−E₀ excites the material from state E₀ to state E₁ and, thus, increases the population of state E₁ above its thermal equilibrium value. Endothermic, nonradiative redistribution processes bring the populations of states E₂ and E₁ into thermal equilibrium by raising some of the E₁ excitations to E₂. This process extracts energy from the solid material. The excitations eventually radiatively decay emitting photons at both E₂−E₀ and E₁−E₀. The mean photon energy of the emitted radiation thus is higher than that of the light radiation that drives the cooling cycle at energy E₁−E₀. Since the brightness temperature of the laser radiation is much higher than the ambient temperature, the cooling cycle is driven in the desired direction. It is to be noted that the excited states E₁ and E₂ can be formed from from one or plural manifolds of sub-states. Throughout this disclosure, this cooling cycle is referred to as fluorescent cooling or anti-Stokes cooling.

A low rate of nonradiative decays can greatly diminish the cooling efficiency. In a fluorescent refrigerator, the nonradiative redistribution processes between states E₁ and E₂ preferably maintain these states nearly in thermal equilibrium with each other. The nonradiative redistribution processes between the states E₁ and E₂ and the E₀ state, on the other hand, are slow compared to the radiative decay rate. The populations of these states, then, are determined principally by the light pumping rate and radiative decay rate. The light radiation, which pumps the populations of states E₁ and E₂, has a brightness temperature far higher than the ambient temperature, and can pump the states E₁ and E₂ such that the emitted radiation is much brighter than ambient temperature over the bandwidth of the fluorescent lines. The high brightness of the fluorescent radiation ensures that the ambient radiation at the ambient temperature does not upset the fluorescent cooling process.

To achieve efficient refrigeration cycle, the nonradiative redistribution rates between the ground state E₀ and the excited states E₁ and E₂ are preferably small compared to the radiative decay rates, and that the upper energy levels E₁ and E₂ be sufficiently close together to ensure the rapid equilibration of the upper levels at temperature T_{c}.

In the present invention, the optical signal provided at input 106 has photons with energy substantially equal to the energy difference E₁−E₀. Accordingly, the optical signal having wavelength λ₂ corresponds to the pump light for achieving as fluorescent cooling. The material chosen from the component of the modulator 104 that selectively undergoes fluorescent cooling preferably has energetics which allow a fluorescent cooling that substantially matches the thermal heating, absent the fluorescent cooling, that would result from non-radiative energy transfer processes not contributing to the optical modulation. The materials that can be used to form the component of the modulator 104 that selectively undergoes anti-Stokes transitions and that performs the modulating action include, but are not limited to, any of ytterbium-doped ZBLAN (heavy metal fluoride glass containing zirconium, barium, lanthanum, aluminum, and sodium) and ytterbium doped ZBLANP (heavy metal fluoride glass containing zirconium, barium, lanthanum, aluminum, sodium and lead). Other materials and compounds can also be used including, but not limited to, ytterbium-doped fluorozirconate glass, thulium-doped glass (for example thulium-doped fluorozirconate glass), ytterbium-doped fluorochloride glass (Yb:CNBZn), ytterbium-doped fluoride glass (YB:BIG), ytterbium-doped crystals (for example, but not limited to, Yb:KGd(WO₄)₂ and Yb:YAG and Yb:Y₂SO₅), dyes such as Rhodmine 101, and 111-V semiconductors such as GaAsAl. Additionally, other low phonon energy glasses or crystals doped with rare-earths can be used as the material undergoing anti-Stokes transitions. The materials given herein are only as examples of materials that allow fluorescent cooling and index of refraction change due to an input optical having wavelength λ₂, and are not meant as exclusive materials for use. Rather any suitable material can be used in practicing this invention.

In an exemplary optional implementation, the modulator 104 is surrounded by a layer of material that highly reflects light at wavelength λ₂, but that highly transmits light at wavelength λ₃ (corresponding to the anti-Stokes generated wavelength) and at wavelength λ₁. For example, the highly reflecting material can be painted, laid on, or grown as a coating onto most of the surfaces (excluding the entry point input of the signal at wavelength λ₂) of the component of the modulator 104 undergoing anti-Stokes transitions). Such an implementation optimizes the use of the optical signal λ₂ by making the unused portion of the input optical signal λ₂ available to contribute to the fluorescent cooling, but facilitates removal of energy by transmitting the light at wavelength λ₃. Optionally, the highly reflecting material can be implemented as a highly polished surface, a diffusing surface, or a combination of both.

Additionally, the modulator 104 is operatively connected to the output 108, to which it delivers the selectively transmitted optical signal at wavelength λ₁. Optionally, the operative connection includes an optical relay arrangement implemented using a lens or a mirror, for example. The transmitted optical signal at wavelength λ₁ can be taken out from output 108 by a free space or material waveguide. A fiber can be used to take out the optical signal at wavelength λ₁ from output 108. Additionally, an optical relay arrangement (including, but not limited to, a lens or a mirror) can be used as an interface between the taking out waveguide and output 108. In various exemplary implementations, optionally, one or both of the waveguide and the interface can form part of apparatus 100. The optical signal at wavelength λ₁ taken out of output 108 can then optionally be used for further processing, modulation, or switching.

Moreover, the modulator 104 is operatively connected to the output 110, to which it delivers the selectively reflected optical signal at wavelength λ₁. Optionally, the operative connection includes an optical relay arrangement implemented using a lens or a mirror, for example. The reflected optical signal at wavelength λ₁ can be taken out from output 110 by a free space or material waveguide. A fiber can be used to take out the optical signal at wavelength λ₁ from output 110. Additionally, an optical relay arrangement (including, but not limited to, a lens or a mirror) can be used as an interface between the taking out waveguide and output. In various exemplary implementations, optionally, one or both of the waveguide and the interface can form part of apparatus 100. The optical signal at wavelength λ₁ delivered to output 110 can then optionally be used for further processing, modulation, or switching.

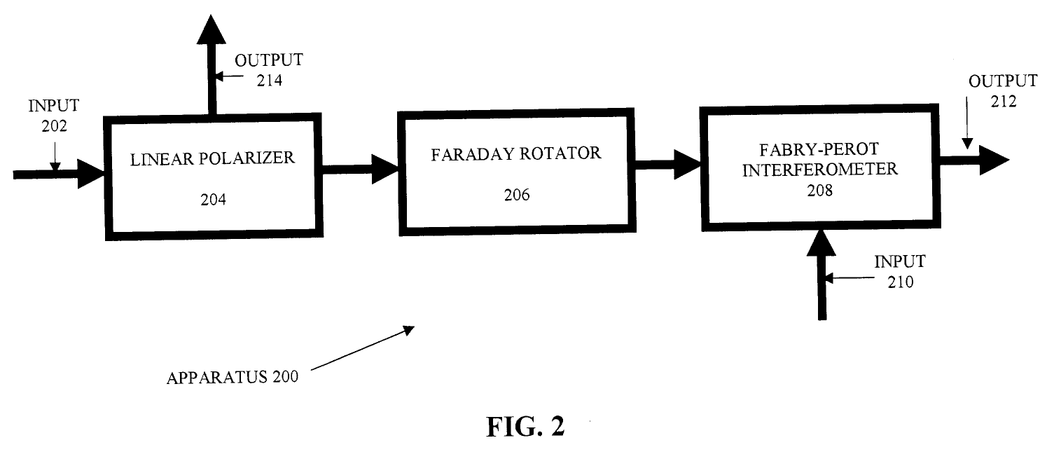

FIG. 2 is a block diagram showing an exemplary implementation of the invention as apparatus 200. The apparatus 200 at least includes a first input 202, a polarizer 204 operatively connected to the first input 202, a Faraday rotator 206 operatively connected to the polarizer 204, a Fabry-Perot interferometer 208 operatively connected to the Faraday rotator 206, a second input 210 operatively connected to the Fabry-Perot interferometer 208, an output 212, operatively connected to the Fabry-Perot interferometer 208, and an output 214 operatively connected to the polarizer 204.

During operation, the apparatus 200 can receive at input 202 an optical signal at wavelength λ₁. The optical signal can be delivered to input 202 by a free space or material waveguide. A fiber can be used to deliver the optical signal to input 202. Additionally, an optical relay arrangement (including, but not limited to, a lens or a mirror) can be used as an interface between the delivery waveguide and input 202. In various exemplary implementations, optionally, one or both of the waveguide and the interface can form part of apparatus 200.

During operation, the apparatus 200 can also receive at input 210 an optical signal at wavelength λ₂. The optical signal can be delivered to input 210 by a free space or material waveguide. A fiber can be used to deliver the optical signal to input 210. Additionally, an optical relay arrangement (including, but not limited to, a lens or a mirror) can be used as an interface between the delivery waveguide and input 210. In various exemplary implementations, optionally, one or both of the waveguide and the interface can form part of apparatus 200.

The polarizer 204 is operatively connected to the input 202, from which it receives the optical signal at wavelength λ₁. Optionally, the operative connection includes an optical relay arrangement implemented using a lens or a mirror, for example. In an exemplary implementation, the polarizer 204 is operatively arranged to linearly polarize the received optical signal at wavelength λ₁. In an exemplary implementation, the polarizer 204 has a plane that is tilted with respect to the path of the optical signal at wavelength λ₁ as it propagates from the input 202 to the polarizer 204. In an exemplary implementation, the polarizer 204 can be formed as a multilayer thin film.

The Faraday rotator 206, which is well known in the art to be a magneto-optical device that rotates the polarization of a light signal propagating through it, is operatively connected to the polarizer 204, from which it receives the polarized optical signal at wavelength λ₁. In an exemplary implementation, the Faraday rotator 206 is operatively arranged to rotate by about 45 degrees the linearly polarized optical signal at wavelength λ₁, as it propagates through the Faraday rotator 206.

The Fabry-Perot interferometer 208 is operatively connected to the Faraday rotator 206, from which it receives the optical signal at wavelength λ₁, rotated linear polarization. In an exemplary implementation, the Fabry-Perot interferometer 208 (the static interferometric function of which is based on principles well known in the art) has a plane perpendicular to the path of the optical signal, having rotated polarization, at wavelength λ₁ as it propagates from the Faraday rotator 206 to the Fabry-Perot interferometer 208.

The Fabry-Perot interferometer 208 is also operatively connected to the input 210, from which it receives the optical signal at wavelength λ₂.

The classic Fabry-Perot interferometer can be formed by two parallel plane surfaces that are separated by a distance d and that have reflectivities of R₁ and R₂ at wavelength λ. The proper choice of the distance d results in a constructive interference of an incident optical signal at wavelength λ with a resulting transmission having a bandwidth depending on the reflectivities R₁ and R₂. The Fabry-Perot interferometer can also be formed to include an etalon, which is a fixed dielectric having a thickness t and two parallel plane surfaces that are separated by a distance d and that have reflectivities of R₁ and R₂. The Fabry-Perot interferometer, in its various forms, can optionally include optics relaying the optical signal to one or the other of its two reflective surfaces, or to both. For further explanation regarding the principle of operation of a Fabry-Perot interferometer and multiple beam interference, reference is made to the section titled “Multiple-Beam Interference” in “Principles of Optics,” by Max Born and Emil Wolf, pp. 323-367, Sixth Edition (1980), which is explicitly incorporated by reference in its entirety in this disclosure and for all purposes.

In an exemplary implementation, the Fabry-Perot interferometer 208 preferably includes an etalon formed from a material that changes its dielectric constant in response to the optical signal having wavelength λ₂. The material chosen to from the etalon preferably also has energetics which allow a fluorescent cooling that substantially matches the thermal heating, absent the fluorescent cooling, that would result from non-radiative energy transfer processes not contributing to the optical modulation. The materials that can be used to form the etalon, with selectively changing index of refraction and selectively undergoing anti-Stokes cooling, include, but are not limited to, any of ytterbium doped ZBLAN (heavy metal fluoride glass containing zirconium, barium, lanthanum, aluminum, and sodium) and ytterbium doped ZBLANP (heavy metal fluoride glass containing zirconium, barium, lanthanum, aluminum, sodium and lead). Other materials and compounds can also be used including III-V semiconductors such as GaAsAl. These materials are given only as examples of materials that allow fluorescent cooling and index of refraction change due to an input optical having wavelength λ₂, and are not meant as exclusive materials for use. Rather any suitable material can be used in forming the etalon.

In an exemplary optional implementation, the etalon is surrounded by a layer of material that highly reflects light at wavelength λ₂, but that highly transmits light at wavelength λ₃ (corresponding to the anti-Stokes generated wavelength) and at wavelength λ₁. For example, the highly reflecting material can be painted, laid on, or grown as a coating onto most of the surfaces (excluding the entry point input of the signal at wavelength λ₂) of the component of the modulator 104 undergoing anti-Stokes transitions. Such an implementation optimizes the use of the optical signal λ₂ by making the unused portion of the input optical signal λ₂ available to contribute to the fluorescent cooling, but facilitates removal of energy by transmitting the light at wavelength λ₃. Optionally, the highly reflecting material can be implemented as a highly polished surface, a diffusing surface, or a combination of both.

Responsive to the optical signal at wavelength λ₂, the Fabry-Perot interferometer 208 is operatively arranged to selectively transmit the incident optical signal at wavelength λ₁, having rotated polarization, to the output 210, or reflect it to the Faraday rotator 206. In an exemplary implementation, the Fabry-Perot interferometer 208 is operatively arranged to respond to the absence of the optical signal at wavelength λ₂ by causing the constructive interference of the plural reflections of the incident optical signal at wavelength λ₁, having rotated polarization, within the Fabry-Perot interferometer 208 and, thus, transmit the incident optical signal at wavelength λ₁, having rotated polarization, to the output 212. This can be achieved, for example, by designing the Fabry-Perot interferometer 208 to have an etalon with an optical length, in the absence of the optical signal at wavelength λ₂, that is a positive integer multiple of half wavelengths of the optical signal at wavelength λ₁.

In this exemplary implementation, the Fabry-Perot interferometer 208 is operatively arranged to respond to the presence of the optical signal at wavelength λ₂ by causing the destructive interference of the plural reflections of the incident optical signal at wavelength λ₁, having rotated polarization, within the Fabry-Perot interferometer 208 and, thus, reflect the incident optical signal at wavelength λ₁, having rotated polarization, back to the Faraday rotator 206. This can be achieved, for example, by designing the Fabry-Perot interferometer 208 to have an etalon with an optical length, in the presence of the optical signal at wavelength λ₂, that is a quarter wavelength plus a positive integer multiple of half wavelengths of the optical signal at wavelength λ₁. The Fabry-Perot 208 is operatively arranged to change the dielectric constant of included etalon, for example, in response to the presence of the optical signal at wavelength λ₂, which response effectuates the change in the optical path within the Fabry-Perot interferometer 208 and causes the selective reflection of the optical signal at wavelength λ₁,

In an alternative exemplary implementation, the Fabry-Perot interferometer 208 is operatively arranged to respond to the absence of the optical signal at wavelength λ₂ by causing the destructive interference of the plural reflections of the incident optical signal at wavelength λ₁, having rotated polarization, within the Fabry-Perot interferometer 208 and, thus, reflect the incident optical signal at wavelength λ₁, having rotated polarization, back to the Faraday rotator 206. This can be achieved, for example, by designing the Fabry-Perot interferometer 208 to have an etalon with an optical length, in the absence of the optical signal at wavelength λ₂, that is a quarter wavelength plus a positive integer multiple of half wavelengths of the optical signal at wavelength λ₁.

In this alternative exemplary implementation, the Fabry-Perot interferometer 208 is operatively arranged to respond to the presence of the optical signal at wavelength λ₂ by causing the constructive interference of the plural reflections of the incident optical signal at wavelength λ₁, having rotated polarization, within the Fabry-Perot interferometer 208 and, thus, transmit the incident optical signal at wavelength λ₁, having rotated polarization, to the output 212. This can be achieved, for example, by designing the Fabry-Perot interferometer 208 to have an etalon with an optical length, in the presence of the optical signal at wavelength λ₂, that is a positive integer multiple of half wavelengths of the optical signal at wavelength λ₁. The Fabry-Perot 208 is operatively arranged to change the dielectric constant of included etalon, for example, in response to the presence of the optical signal at wavelength λ₂, which response effectuates the change in the optical path within the Fabry-Perot interferometer 208 and causes the selective transmission of the optical signal at wavelength λ₁,

In yet another alternative exemplary implementation, the Fabry-Perot interferometer 208 is operatively arranged to respond to a first intensity of the optical signal at wavelength λ₂ by causing the destructive interference of the plural reflections of the incident optical signal at wavelength λ₁, having rotated polarization, within the Fabry-Perot interferometer 208 and, thus, reflect the incident optical signal at wavelength λ₁, having rotated polarization, back to the Faraday rotator 206. This can be achieved, for example, by designing the Fabry-Perot interferometer 208 to have an etalon with an optical length, in the presence of the first intensity of the optical signal at wavelength λ₂, that is a quarter wavelength plus a positive integer multiple of half wavelengths of the optical signal at wavelength λ₁.

In this yet another alternative exemplary implementation, the Fabry-Perot interferometer 208 is operatively arranged to respond to the presence of a second intensity of the optical signal at wavelength λ₂ by causing the constructive interference of the plural reflections of the incident optical signal at wavelength λ₁, having rotated polarization, within the Fabry-Perot interferometer 208 and, thus, transmit the incident optical signal at wavelength λ₁, having rotated polarization, to the output 212. This can be achieved, for example, by designing the Fabry-Perot interferometer 208 to have an etalon with an optical length, in the presence of the second intensity of the optical signal at wavelength λ₂, that is a positive integer multiple of half wavelengths of the optical signal at wavelength λ₁. In this another exemplary implementation, therefore, the Fabry-Perot 208 is operatively arranged to change the dielectric constant of included etalon in response to a variation of the optical signal at wavelength λ₂, which response effectuates the change in the optical path within the Fabry-Perot interferometer 208 and causes the selective transmission or reflection of the optical signal at wavelength λ₁.

In the exemplary implementations described above with respect to FIG. 2, the Fabry-Perot interferometer 208 is preferably operatively arranged to transmit substantially all or reflect substantially all of the optical signal at wavelength λ₁, responsive to the optical signal at wavelength λ₂. Alternatively, however, in various other exemplary implementations of the invention, the Fabry-Perot interferometer 208 is preferably operatively arranged to transmit less than substantially all and reflect less than substantially all of the optical signal at wavelength λ₁, responsive to the optical signal at wavelength λ₂. This can be achieved, for example, by operatively arranging for partial constructive and destructive interferences.

The optical signal at wavelength λ₁ selectively transmitted through the Fabry-Perot interferometer 208 is delivered to output 212. Optionally, the operative connection to output 212 includes an optical relay arrangement implemented using a lens or a mirror, for example. The optical signal at wavelength λ₁ delivered to output 212 can then optionally be used for further processing, modulation, or switching.

The optical signal at wavelength λ₁ selectively reflected from the Fabry-Perot interferometer 208 is directed back to the Faraday rotator 206. In an exemplary implementation, the Faraday rotator 206 rotates the polarization of the reflected optical signal at wavelength λ₁ by a further 45 degrees, thus making the reflected optical signal at wavelength λ₁ have a polarization rotated substantially orthogonaly (in the linear polarization implementation, a total of about 90 degrees) with respect to the polarization transmitted by the linear polarizer 204. Accordingly, the polarizer 204 directs the reflected optical signal at wavelength λ₁ to the output 214.

Optionally, the operative connection between the Fabry-Perot interferometer 210 and the output 212 includes an optical relay arrangement implemented using a lens or a mirror, for example. The transmitted optical signal at wavelength λ₁ can be taken out from output 212 by a free space or material waveguide. A fiber can be used to take out the optical signal at wavelength λ₁ from output 212. Additionally, an optical relay arrangement (including, but not limited to, a lens or a mirror) can be used as an interface between the taking out waveguide and output 212. In various exemplary implementations, optionally, one or both of the waveguide and the interface can form part of apparatus 200. The optical signal at wavelength λ₁ taken out of output 212 can then optionally be used for further processing, modulation, or switching.

Also, optionally, the operative connection between the polarizer 204 and the output 214 includes an optical relay arrangement implemented using a lens or a mirror, for example. The reflected optical signal at wavelength λ₁ can be taken out from output 214 by a free space or material waveguide. A fiber can be used to take out the optical signal at wavelength λ₁ from output 214. Additionally, an optical relay arrangement (including, but not limited to, a lens or a mirror) can be used as an interface between the taking out waveguide and output. In various exemplary implementations, optionally, one or both of the waveguide and the interface can form part of apparatus 200. The optical signal at wavelength λ₁ delivered to output 214 can then optionally be used for further processing, modulation, or switching.

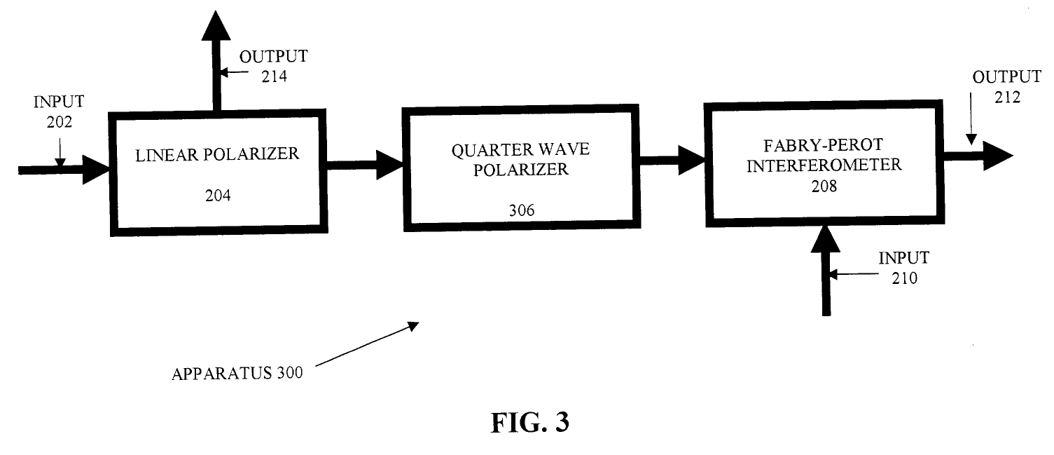

FIG. 3 is a block diagram showing an exemplary implementation of the invention as apparatus 300. The apparatus 300 at least includes a first input 202, a polarizer 204 operatively connected to the first input 202, a quarter-wave plate 306 operatively connected to the polarizer 204, a Fabry-Perot interferometer 208 operatively connected to quarter-wave plate 306, a second input 210 operatively connected to the Fabry-Perot interferometer 208, an output 212, operatively connected to the Fabry-Perot interferometer 208, and an output 214 operatively connected to the polarizer 204. The components of apparatus 300 and apparatus 200 that are numbered the same are similar and, for convenience, their description, exemplary implementations, operative connections, and operation with respect to FIG. 3 are not repeated.

The quarter-wave plate 306, which is well known in the art, is operatively connected to the polarizer 204, from which it receives the polarized optical signal at wavelength λ₁. In an exemplary implementation, the quarter-wave plate 306 is operatively arranged to convert the linearly polarized optical signal at wavelength λ₁ arriving from the polarizer 204 to a circularly polarized optical signal at wavelength λ₁ as it propagates through the quarter-wave plate 306 towards the Fabry-Perot interferometer 208. In an exemplary implementation, the quarter-wave plate 306 is also operatively arranged to convert the circularly polarized optical signal at wavelength λ₁ reflected from the Fabry-Perot interferometer 208 to a linearly polarized optical signal at wavelength λ₁ that has a polarization perpendicular to the polarization transmitted by the polarizer 204 and, accordingly, is operatively arranged to direct towards the output 214 the optical signal at wavelength λ₁ selectively reflected by the Fabry-Perot interferometer 208. In an exemplary and non-limiting implementation, the quarter-wave plate 306 can be implemented as a multilayer dielectric material.

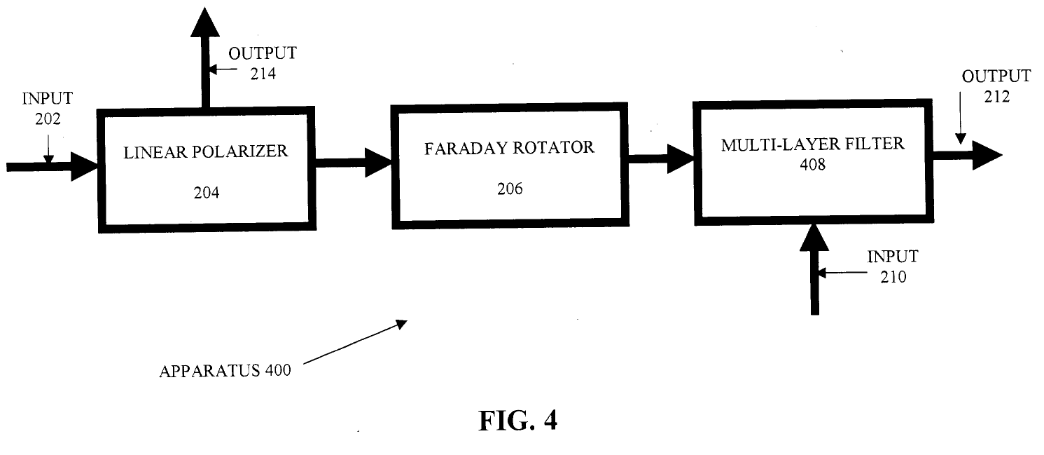

FIG. 4 is a block diagram showing an exemplary implementation of the invention as apparatus 400. The apparatus 400 at least includes a first input 202, a polarizer 204 operatively connected to the first input 202, a Faraday rotator 206 operatively connected to the polarizer 204, a multilayer filter 408 operatively connected to the Faraday rotator 206, a second input 210 operatively connected to the multilayer filter 408, an output 212, operatively connected to the multilayer filter 208, and an output 214 operatively connected to the polarizer 204. The components of apparatus 400 and apparatus 200 that are numbered similarly are the same (except for a circularly polarized optical signal at wavelength λ₁ replacing the linearly polarized optical signal at wavelength λ₁) and, accordingly, their description, exemplary implementations, operative connections, and operation with respect to FIG. 4 are not repeated.

The multilayer filter 408 is operatively connected to the Faraday rotator 206, from which it receives the rotated linearly polarized optical signal at wavelength λ₁. In an exemplary implementation, the multilayer filter 408 (the static interferometric function of which is based on principles well known in the art) has a plane substantially perpendicular to the path of the optical signal, having rotated polarization, at wavelength λ₁ as the latter propagates from the Faraday rotator 206 to the multilayer filter 408. It is to be noted that the angle between the plane of the multi-layer filter 408 and the travel path of the optical signal at wavelength λ₁ can be desinged according to user preference.

The multilayer filter 408 is also operatively connected to the input 210, from which it receives the optical signal at wavelength λ₂.

The classic multilayer filter interferometer can be formed by at least two layers having thickness t₁ and t₂ and relative dielectric constants ε₁ and ε₂ at wavelength λ. The proper choice of the thickness and relative dielectric constants results in a constructive interference of an incident optical signal at wavelength λ with a resulting transmission having a bandwidth depending on the number of thin films, their thickness and their relative dielectric constants. For further explanation regarding the principle of operation of a multilayer filter interferometer and multiple beam interference, reference is made to the section titled “Multiple-Beam Interference” in “Principles of Optics,” by Max Born and Emil Wolf, pp. 323-367, Sixth Edition (1980), which is explicitly incorporated by reference in its entirety in this disclosure and for all purposes; reference is also made to “Optical Properties of Thin Solid Films,” by O. S. Heavens, pp. 62-96 and 207-242 (describing reflection and transmission of light by two films, the extension to a system of multiple layers, optical impedance, matrix methods using Fresnel coefficients, application of matrix methods for evaluation of reflectance and transmittance, graphical methods as approximations for transparent layers, general graphical methods, the phase change on reflection at or transmission through a thin film, general theory of doubly refracting films, practical applications of thin films in optics, anti-reflecting systems, high-efficiency reflecting systems, all-dielectric high-reflecting films in interferometry, interference films, the frustrated total reflection filter, comparison of multilayer filters with other narrow pass-band filters, and the use of thin films as polarizers) (1991, corrected Dover republication) which is also explicitly incorporated by reference in its entirety in this disclosure and for all purposes.

In an exemplary implementation, the multilayer filter 408 is preferably formed from two or more layers, including at least one layer that is formed from a material that changes its dielectric constant in response to the optical signal having wavelength λ₂. The multilayer filter 408 preferably also includes at least one layer that is formed from a material that has energetics which allow a fluorescent cooling that substantially matches the thermal heating, absent the fluorescent cooling, that would result from non-radiative energy transfer processes not contributing to the optical modulation. The materials that can be used to form the multilayer filter 408, with selectively changing index of refraction and selectively undergoing anti-Stokes cooling, include, but are not limited to, any of ytterbium doped ZBLAN (heavy metal fluoride glass containing zirconium, barium, lanthanum, aluminum, and sodium) and ytterbium doped ZBLANP (heavy metal fluoride glass containing zirconium, barium, lanthanum, aluminum, sodium and lead). Other materials and compounds can also be used including III-V semiconductors such as GaAsAl. These materials are given only as examples of materials that allow fluorescent cooling and index of refraction change due to an optical input signal having wavelength λ₂, and are not meant as exclusive materials for use. Rather any suitable material can be used in forming the etalon.

In an exemplary implementation, the multilayer filter 408 is preferably formed from two or more layers, including at least one layer that is formed from a material that changes its dielectric constant in response to the optical signal having wavelength λ₂, wherein this at least one layer has energetics that allow a fluorescent cooling in response to the optical signal having wavelength λ₂. In another exemplary implementation, the at least one layer that changes its dielectric constant in response to the optical signal having wavelength λ₂ is different from the at least one layer that has energetics that allow a fluorescent cooling. Accordingly, this another exemplary implementation can be further modified by optionally using a third optical signal having a wavelength λ₃, different from λ₂, to effectuate the fluorescent cooling of the multilayer filter 408. In an exemplary implementation using different layers for dielectric constant change and fluorescent cooling, the multilayer filter 408 is operatively arranged to provide thermal contact between at least these two layers to effectuate the cooling of the dielectric constant changing layer.

In an exemplary optional implementation, the multilayer filter 408 is surrounded by a layer of material that highly reflects light at wavelength λ₂, but that highly transmits light at wavelength λ₃ (corresponding to the anti-Stokes generated wavelength) and at wavelength λ₁. For example, the highly reflecting material can be painted, laid on, or grown as a coating onto most of the surfaces (excluding the entry point input of the signal at wavelength λ₂) of the multilayer filter 408 (or, alternatively, the surfaces of the layer having the fluorescent cooling characteristic). Such an implementation optimizes the use of the optical signal λ₂ by making the unused portion of the input optical signal λ₂ available to contribute to the fluorescent cooling, but facilitates removal of energy by transmitting the light at wavelength λ₃. Optionally, the highly reflecting material can be implemented as a highly polished surface, a diffusing surface, or a combination of both.

Responsive to the optical signal at wavelength λ₂, the multilayer filter 408 is operatively arranged to selectively transmit the incident optical signal at wavelength λ₁, having rotated polarization, to the output 210, or reflect it to the Faraday rotator 206. In an exemplary implementation, the multilayer filter 408 is operatively arranged to respond to the absence of the optical signal at wavelength λ₂ by causing the constructive interference of the plural reflections of the incident optical signal at wavelength λ₁, having rotated polarization, within the multilayer filter 408 and, thus, transmit the incident optical signal at wavelength λ₁, having rotated polarization, to the output 212. This can be achieved, for example, by designing the multilayer filter 408 to have an effective optical length, in the absence of the optical signal at wavelength λ₂, that is a positive integer multiple of half wavelengths of the optical signal at wavelength λ₁.

In this exemplary implementation, the multilayer filter 408 is operatively arranged to respond to the presence of the optical signal at wavelength λ₂ by causing the destructive interference of the plural reflections of the incident optical signal at wavelength λ₁, having rotated polarization, within the multilayer filter 408 and, thus, reflect the incident optical signal at wavelength λ₁, having rotated polarization, back to the Faraday rotator 206. This can be achieved, for example, by designing the multilayer filter 408 to have an effective optical length, in the presence of the optical signal at wavelength λ₂, that is a quarter wavelength plus a positive integer multiple of half wavelengths of the optical signal at wavelength λ₁. The multilayer filter 408 is operatively arranged to change the dielectric constant of the at least one fluorescent cooling active layer, for example, in response to the optical signal at wavelength λ₂, which response effectuates the change in the effective optical path within the multilayer filter 408 and causes the selective reflection of the optical signal at wavelength λ₁,

In an alternative exemplary implementation, the multilayer filter 408 is operatively arranged to respond to the absence of the optical signal at wavelength λ₂ by causing the destructive interference of the plural reflections of the incident optical signal at wavelength λ₁, having rotated polarization, within the multilayer filter 408 and, thus, reflect the incident optical signal at wavelength λ₁, having rotated polarization, back to the Faraday rotator 206. This can be achieved, for example, by designing the multilayer filter 408 to have an effective optical length, in the absence of the optical signal at wavelength λ₂, that is a quarter wavelength plus a positive integer multiple of half wavelengths of the optical signal at wavelength λ₁.

In this alternative exemplary implementation, the multilayer filter 408 is operatively arranged to respond to the presence of the optical signal at wavelength λ₂ by causing the constructive interference of the plural reflections of the incident optical signal at wavelength λ₁, having rotated polarization, within the multilayer filter 408 and, thus, transmit the incident optical signal at wavelength λ₁, having rotated polarization, to the output 212. This can be achieved, for example, by designing the multilayer filter 408 to have an effective optical length, in the presence of the optical signal at wavelength λ₂, that is a positive integer multiple of half wavelengths of the optical signal at wavelength λ₁.

In yet another alternative exemplary implementation, the multilayer filter 408 is operatively arranged to respond to a first intensity of the optical signal at wavelength λ₂ by causing the destructive interference of the plural reflections of the incident optical signal at wavelength λ₁, having rotated polarization, within the multilayer filter 408 and, thus, reflect the incident optical signal at wavelength λ₁, having rotated polarization, back to the Faraday rotator 206. This can be achieved, for example, by designing the multilayer filter 408 to have an effective optical length, in the presence of the first intensity of the optical signal at wavelength λ₂, that is a quarter wavelength plus a positive integer multiple of half wavelengths of the optical signal at wavelength λ₁.

In this yet another alternative exemplary implementation, the multilayer filter 408 is operatively arranged to respond to the presence of a second intensity of the optical signal at wavelength λ₂ by causing the constructive interference of the plural reflections of the incident optical signal at wavelength λ₁, having rotated polarization, within the multilayer filter 408 and, thus, transmit the incident optical signal at wavelength λ₁, having rotated polarization, to the output 212. This can be achieved, for example, by designing the multilayer filter 408 to have an effective optical length, in the presence of the second intensity of the optical signal at wavelength λ₂, that is a positive integer multiple of half wavelengths of the optical signal at wavelength λ₁. In this another exemplary implementation, therefore, the multilayer filter 408 is operatively arranged to change the dielectric constant of included etalon in response to a variation of the optical signal at wavelength λ₂, which response effectuates the change in the optical path within the multilayer filter 408 and causes the selective transmission or reflection of the optical signal at wavelength λ₁.

In the exemplary implementations described above with respect to FIG. 4, the multilayer filter 408 is preferably operatively arranged to transmit substantially all or reflect substantially all of the optical signal at wavelength λ₁, responsive to the optical signal at wavelength λ₂. Alternatively, however, in various other exemplary implementations of the invention, the multilayer filter 408 is preferably operatively arranged to transmit less than substantially all and reflect less than substantially all of the optical signal at wavelength λ₁, responsive to the optical signal at wavelength λ₂. This can be achieved, for example, by operatively arranging for partial constructive and destructive interferences.

The optical signal at wavelength λ₁ selectively transmitted through the multilayer filter 408 is delivered to output 212. Optionally, the operative connection to output 212 includes an optical relay arrangement implemented using a lens or a mirror, for example. The optical signal at wavelength λ₁ delivered to output 212 can then optionally be used for further processing, modulation, or switching.

The optical signal at wavelength λ₁ selectively reflected from the multilayer filter 408 is directed back to the Faraday rotator 206. In an exemplary implementation, the Faraday rotator 206 rotates the polarization of the reflected optical signal at wavelength λ₁ by a further 45 degrees, thus making the reflected optical signal at wavelength λ₁ have a polarization rotated substantially orthogonaly (in the linear polarization implementation, a total of about 90 degrees) with respect to the polarization transmitted by the linear polarizer 204. Accordingly, the polarizer 204 directs the reflected optical signal at wavelength λ₁ to the output 214.

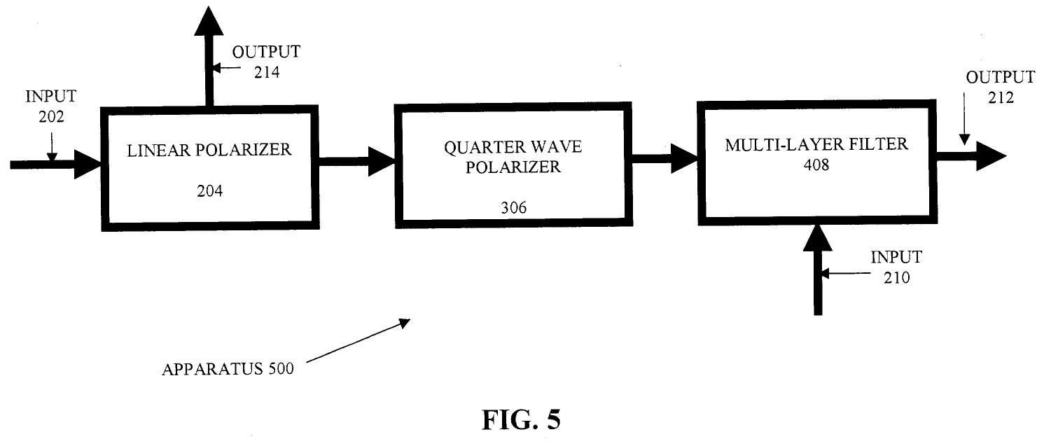

FIG. 5 is a block diagram showing an exemplary implementation of the invention as apparatus 500. The apparatus 300 at least includes a first input 202, a polarizer 204 operatively connected to the first input 202, a quarter-wave plate 306 operatively connected to the polarizer 204, a multilayer filter 408 operatively connected to quarter-wave plate 306, a second input 210 operatively connected to the multilayer filter 408, an output 212, operatively connected to the multilayer filter 408, and an output 214 operatively connected to the polarizer 204. The components of apparatus 500 and apparatuses 300 and 400 that are numbered the same are similar and, for convenience, their description, exemplary implementations, operative connections, and operation with respect to FIG. 5 are not repeated.

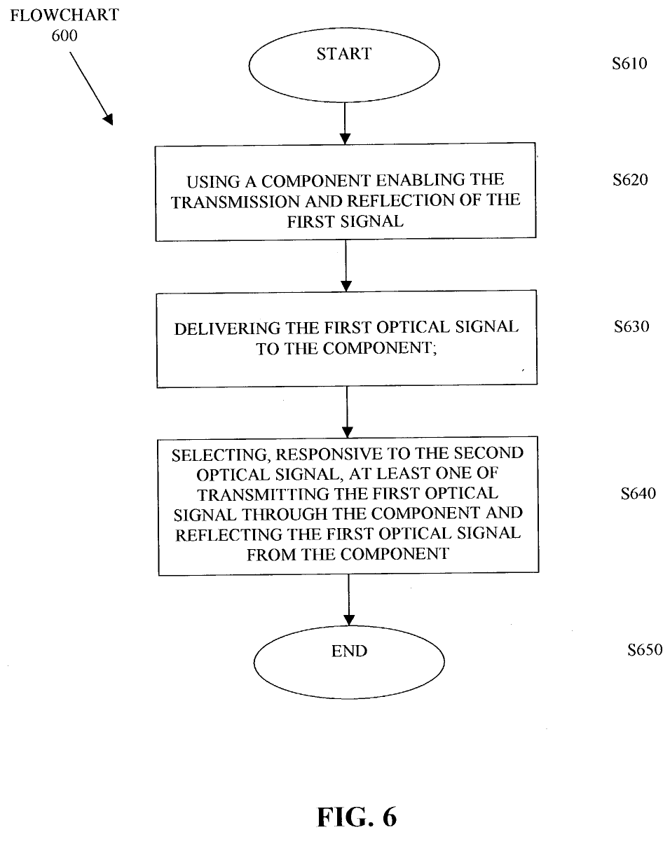

FIG. 6 is a flowchart outlining steps in an exemplary method for practicing the invention, by which a first optical signal having a wavelength λ₁ is modulated in response to a second optical signal having a wavelength λ₂. Beginning in step 600, operation continues to step 610, which includes using a component enabling the transmission and reflection of a first signal at wavelength λ₁. Step 620 follows step 610 and includes delivering the optical signal at wavelength λ₁ to the component. Step 630 follows step 620 and includes selecting, responsive to a second optical signal at wavelength λ₂, at least one of transmitting the first optical signal through the component and reflecting the first optical signal from the component. Step 640 follows step 630 and includes performing fluorescent cooling of at least a first portion of the component. The process proceeds to step 650 where it terminates

In Step 620, various kinds of optical signals at λ₁ can be delivered. The transmitted or reflected optical signal at wavelength λ₁, resulting from step 630, can be subjected to optional further processing including, but not limited to, modulation and switching.

In various exemplary implementations of the steps of the flowchart 600 exemplifying the invention, step 640 optionally includes performing the fluorescent cooling of the at least the first portion of the component is responsive to the optical signal at wavelength λ₂. In various exemplary implementations of the steps of the invention, the transmitted first optical signal has a polarization that is substantially orthogonal to the polarization of the reflected first optical signal.

In various exemplary implementations of the steps of the flowchart 600 exemplifying the invention, step 630 is effectuated by causing at least one of constructive and destructive interference within at least a second portion of the component, responsive to the second optical signal, which causing at least one of constructive and destructive interference effectuates selecting at least one of transmitting the first optical signal through the component and reflecting the first optical signal from the component.

In various exemplary implementations of the steps of the flowchart 600 exemplifying the invention, the constructive or destructive interference within at least the second portion of the component (which can be used to effectuate step 630) is due to a change in the dielectric constant of the at least a second portion of the component responsive to the second optical signal. In various exemplary implementations of the steps of the flowchart 600 exemplifying the invention, the first and the second portions of the component are the same. In various exemplary implementations of the steps of the invention, the first and the second portions of the component are different. In various exemplary implementations of the steps of the flowchart 600 exemplifying the invention, the fluorescent cooling of the at least the first portion of the component is responsive to the second optical signal.

In various exemplary implementations of the steps of the flowchart 600 exemplifying the invention, the transmitted first optical signal has a polarization that is substantially orthogonal to the polarization of the reflected first optical signal. In various exemplary implementations of the steps of the flowchart 600 exemplifying the invention, the fluorescent cooling of the at least the first portion of the component is responsive to the second signal. In various exemplary implementations of the steps of the flowchart 600 exemplifying the invention, the fluorescent cooling of the component is responsive to a third signal having a third wavelength that is different than the second wavelength.

It is to be noted, but not as a limitation, that the various components/elements described with respect to the apparatuses 100-500 can be used to practice the steps of the invention as exemplified in the flowchart 600 schematically described with respect to FIG. 6 and textually described above.

While this invention has been described in conjunction with the exemplary embodiments outlined above, it is evident that many alternatives, modifications, and variations will be apparent to those skilled in the art in view of the present disclosure. Accordingly, the exemplary embodiments of the invention, as set forth above, are intended to be illustrative, not limiting. Various changes, modifications may be made, and various applications implemented, without departing from the spirit and scope of the invention.

For example, the exemplary non-limiting implementations described above can be operatively arranged (by, for example, choosing the anti-Stokes material, its volume relative to other components, or the intensity of the optical signals at wavelengths λ₁ and λ₂, or a combination of these choices) to substantially maintain the temperature of the apparatuses. Alternatively the exemplary non-limiting implementations described above can be operatively arranged (by, for example, choosing the anti-Stokes material, its volume relative to other components, or the intensity of the optical signals at wavelengths λ₁ and λ₂, or a combination of these choices) to lower the temperature of the apparatuses to a desired temperature.

Also, as an exemplary non-limiting implementation, a photonic bandgap material can be used as the dielectric constant changing portion of the modulator, as the anti-Stokes portion of the modulator, or as both, in the modulators of the exemplary implementations according to FIGS. 1-6, and their further modifications, as described in this disclosure. A photonic filter is preferably composed of an ordered array of holes in a transparent dielectric. See, for example, U.S. Pat. No. 5.973,823 to Koops et al., “Ultrafast Switching of Photonic Density of States in Photonic Crystals,” by P. M. Johnson et al., Phys. Rev. B 66, 081102-1-081102-4 (2002), and “Tunable Omnidirectional Reflection Bands and Defect Modes of a One-Dimensional Photonic Band Gap Structure with Liquid Crystals,” by Ha et al., Applied Physics Lett., V-79, No. 1, pp 15-17 (2001), all expressly incorporated herein in their entirety and for all purposes. In exemplary implementations incorporating photonic bandgap materials, the application of the optical signal at wavelength λ₂ will alter the refractive index of the photonic material and effectuate the modulation of the optical signal at wavelength λ₁.

Additionally, apparatuses 100-500, in their various exemplary implementations according to the present invention, can be formed as single integrated structures (or various structures that are then integrated) using any of the heretofore known or later discovered fabrication or manufacturing techniques. Indeed, such an integration and miniaturization, monolithic or otherwise, of the exemplary implementations of the present invention are not limited by the intentionally or inadvertently generated heat. Accordingly, such integration and miniaturization, monolithic or otherwise, of the exemplary implementations of the present invention, accordingly, can be done into much smaller dimensions than heretofore known for optical modulators, processors, or switches. See, for example, U.S. Pat. No. 6,304,362 to Zheludev et al., which is explicitly incorporated by reference in its entirety in this disclosure and for all purposes.

Moreover, although the incident and reflected optical signals at wavelength λ₁ are described as being substantially orthogonal (the planes of linear polarizations being nearly 90 degrees in exemplary implementations using a linear polarizer 204, and clockwise circular polarization verses counter-clock-wise polarization in exemplary implementations using a circular polarizer 204), the invention can be implemented using non-orthogonal polarizations. Additionally, the invention can be implemented using a circular polarizers 204, instead of a linear polarizer 204. Furthermore, although exemplary implementations of this invention were described as effectuating the processing, modulation, or switching of optical signals, the invention can be practiced in implementations modulating, processing, or switching signals having optical wavelengths within a broad spectrum ranging, but not limited to, from the far infrared to ultra-violet.

Also, although exemplary implementations of this invention were described in part as modulating optical signals, the invention can be practiced in implementations modulating, processing, or switching signals having optical wavelengths within a broad spectrum including, but not limited to, far infrared to ultra-violet. The optical signal being modulated, processed, or switched could be originally generated as a laser or a maser from different sources, including but not limited to, solid state, semiconductor, and gas lasers and masers.

Furthermore, the optical signal being modulated, processed, or switched could be originally generated as a laser or a maser from different sources, including but not limited to, solid state, semiconductor, and gas lasers and masers. The invention can be used to provide the original processing, modulation, or switching of the input optical signal; alternatively, the invention can be used to provide processing, modulation, or switching to optical signals that are already modulated.

Additionally, it is to be noted the present invention can be implemented as a network systems including plural of the apparatus 100-500 to achieve “one to many,” “many to one,” and “many to many” connections. In such network systems, preferably a quarter-wave plate is used before the input of an apparatus receiving the optical signal transmitted from an apparatus implemented as one of the exemplary implementations described with respect to FIGS. 3 and 5 (to convert the circularly polarized transmitted optical to linearly polarized optical signal before inputting it to the next stage). Moreover, such network systems can be arranged as a “1 input×n outputs,” “n inputs×1 output,” or “n inputs×m outputs” arranged in linear or two-dimensional configurations. In such implementations, plural of the same apparatus (any of 100-500) can be used; alternatively, the plurality includes different ones of the apparatuses 100-500.

Moreover, it is to be noted that other exemplary implementations can use a polarization rotator that is based on the Kerr effect, instead of (or in addition to) using a polarization rotator based on the Faraday effect. Furthermore, it is also to be noted that a modulator according to the present invention, and as described above by the various exemplary implementations, can be the foundational building block of more complex apparatuses including, but not limited to, phototransistors.

What is claimed is:

1. A method of modulating a first optical signal having a first wavelength in response to a second optical signal having a second wavelength, the method comprising:
using a component enabling the transmission and reflection of the first signal;
delivering the first optical signal to the component;
selecting, responsive to the second optical signal, at least one of transmitting the first optical signal through the component and reflecting the first optical signal from the component; and
performing fluorescent cooling of at least a first portion of the component.

2. The method according to claim 1, wherein the fluorescent cooling of the at least the first portion of the component is responsive to the second optical signal.

3. The method according to claim 1, wherein the transmitted first optical signal has a polarization that is substantially orthogonal to the polarization of the reflected first optical signal.

4. The method according to claim 1, further comprising causing at least one of constructive and destructive interference within at least a second portion of the component, responsive to the second optical signal, which effectuates selecting at least one of transmitting the first optical signal through the component and reflecting the first optical signal from the component.

5. The method according to claim 4, wherein the constructive or destructive interference within at least the second portion of the component is due to a change in the dielectric constant of the at least second portion of the component responsive to the second optical signal.

6. The method according to claim 4, wherein the first and the second portions of the component are the same.

7. The method according to claim 4, wherein the first and the second portions of the component are different.

8. The method according to claim 4, wherein the fluorescent cooling of the at least the first portion of the component is responsive to the second optical signal.

9. The method according to claim 4, wherein the transmitted first optical signal has a polarization that is substantially orthogonal to the polarization of the reflected first optical signal.

10. The method according to claim 4, wherein the fluorescent cooling of at least the first portion of the component is responsive to the second signal.

11. The method according to claim 4, wherein the fluorescent cooling of at least the first portion of the component is responsive to a third signal having a third wavelength that is different than the second wavelength.

12. An apparatus for modulating a first optical signal having a first wavelength in response to a second optical signal having a second wavelength, the apparatus comprising:
a first input operatively arranged to receive the first optical signal;
a second input operatively arranged to receive the second optical signal;
a first output operatively arranged to output a transmitted first optical signal;
a second output operatively arranged to output a reflected first optical signal;
a modulator operatively connected to the first input, from which the modulator receives the first optical signal, operatively connected to the second input, from which the modulator receives the second optical signal, operatively connected to the first output, to which the modulator directs the transmitted first optical signal, operatively connected to the second output, to which the modulator directs the reflected first optical signal, the modulator operatively arranged to transmit or reflect, responsive to the second optical signal, the first optical signal, the modulator having at leas a first portion selectively undergoing fluorescent cooling.

13. The apparatus according to claim 12, wherein the modulator is a Fabry-Perot interferometer.

14. The apparatus according to claim 13, further comprising a Faraday rotator.

15. The apparatus according to claim 13, further comprising a quarter-wave plate.

16. The apparatus according to claim 12, wherein the modulator is a multilayer filter.

17. The apparatus according to claim 16, further comprising a Faraday rotator.

18. The apparatus according to claim 16, further comprising a quarter-wave plate.

19. The apparatus according to claim 12, wherein the fluorescent cooling of the at least the first portion of the apparatus is responsive to the second optical signal.

20. The apparatus according to claim 12, wherein the transmitted first optical signal has a polarization that is substantially orthogonal to the polarization of the reflected first optical signal.

21. The apparatus according to claim 12, wherein the modulator includes a second portion, the modulator being operatively arranged to cause at least one of constructive and destructive interference within at least the second portion, responsive to the second optical signal, which effectuates selecting at least one of directing the transmitted first signal or directing the reflected first signal.

22. The apparatus according to claim 21, wherein the constructive or destructive interference within at least the second portion is due to a change in the dielectric constant of the at least second portion of the component responsive to the second optical signal.

23. The apparatus according to claim 21, wherein the first and the second portions are the same.

24. The apparatus according to claim 21, wherein the first and the second portions are different.

25. The apparatus according to claim 21, wherein the fluorescent cooling of the at least the first portion of the apparatus is responsive to the second optical signal.

26. The apparatus according to claim 21, wherein the transmitted first optical signal has a polarization that is substantially orthogonal to the polarization of the reflected first optical signal.

27. The apparatus according to claim 21, wherein the fluorescent cooling of at least the first portion of the apparatus is responsive to the second signal.

28. The apparatus according to claim 21, wherein the fluorescent cooling of at least the first portion of the apparatus is responsive to a third signal having a third wavelength that is different than the second wavelength.

29. The apparatus according to claim 12, wherein the modulator includes a photonic bandgap material.
